(19) United States
(12) Patent Application Publication
(10) Pub. No.: US 2003/0075455 A1
(43) Pub. Date: Apr. 24, 2003

(54) Electrochemical treatment of metals

(75) Inventors: Gordon Timothy Burstein, Cambridge (GB); Kotaro Sasaki, Upton, NY (US); Ian Michael Hutchings, Cambridge (GB)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Cambridge University Technical Services Ltd.

(21) Appl. No.: 10/039,728

(22) Filed: Oct. 19, 2001

(51) Int. Cl. C25F 1/00; B32B 9/04; B23H 3/00; B23H 5/00

(52) U.S. Cl. 205/710; 428/543

(57) ABSTRACT

A method for treating a metal comprises subjecting the metal to electrolysis in the presence of an electrolyte using alternating pulses of voltage and/or current, said alternating pulses being of opposite polarity, wherein if the electrolyte is an aqueous electrolyte it is an aqueous solution of a salt selected from the group consisting of alkali metal salts, alkali earth metal salts, aluminium salts and amnonium salts. The method is effective in improving the surface properties of the metal, such as hardness, friction and wear properties.

### FIELD OF THE INVENTION

The present intention relates to a method for the electrochemical treatment of metals, and in particular austenitic stainless steels, in order to improve surface properties, such as hardness, friction and wear.

### BACKGROUND TO THE INVENTION

A wide range of metals and metal alloys, and notably austenitic stainless steels, are susceptible to high friction and surface damage associated with the formation of strong adhesive bonds when sliding against metals of the same or similar type, in the absence of effective lubrication. This process is known as galling, and when severe it may result in seizure of moving parts. The susceptibility of austenitic steels to galling prevents their application in fields where they might otherwise be favoured for their corrosion resistance and ductility.

It is known that during cold-working the surfaces of austenitic stainless steels may be transformed to martensite. While martensitic steels are far harder than austenitic steels, they are also more brittle, and can absorb much more hydrogen when in an appropriate environment, leading to further enbrittlement Martensite may be removed from austenitic stainless steels by annealing at high temperature, for instance in excess of 700° C. However, there is a risk with processes of this type that the high temperatures employed may have deleterious effects on the properties of the bulk metal. Furthermore, such processes require high amounts of energy, and are therefore expensive.

Various other methods have been developed for improving the surface properties of austenitic stainless steels, including electroplating, such as chromium plating (see W. G. Wood, Handbook of Stainless Steels (1977), 34-2); thermochemical diffusion processes, such as nitriding, boronising and carburising (see J. R. Davis, ASM Handbook (1994) 5:741); provision of non-metallic coatings by physical vapour deposition (PVD) and chemical vapour deposition (CMD) processes (see S. Rundenja et al, Electrochem. Soc. (1999) 146:4062 and P. Millet et al, J. Mat. Sci. (1996) 21:351); and nitrogen ion implantation (see X. Li et al, Sur. Coat. Tech. (1996) 85:28). However, it is known that chromium plating carries with it serious health and environmental hazards, and the other methods described above cannot readily or economically be applied to relatively large substrates.

Thus, there exists a need for a method for the treatment of metals, and particularly austenitic stainless steels, which is effective in maintaining good surface properties, without having any substantial deleterious effect on bulk properties, which in energy efficient and which may be applied to relatively large substrates.

### SUMMARY OF THE INVENTION

According to the present invention, a method for treating a metal comprises subjecting the metal to electrolysis in the presence of an electrolyte using alternating pulses of voltage and/or current, said alternating pulses being of opposite polarity, wherein if the electrolyte is an aqueous electrolyte it is an aqueous solution of a salt selected from the group consisting of alkali metal salts, alkali earth metal salts, aluminium salts and ammonium salts.

The method is effective in improving the surface properties of the metal, and in particular its hardness, friction, wear, and corrosion resistance properties. The method may be operated at relatively low temperature as compared with conventional thermal annealing processes, thereby protecting the bulk properties of the metal and rendering it applicable to in situ treatments. In relation to austenitic stainless steels, the method is effective in removing or transforming martensite present both at and below the metal surface, and surprisingly, results in an increase in hardness, despite the loss of martensite. The method may also result in an increase in passivity, through the formation of an increased thickness of a protective oxide film usually present on such steels.

### DETAILED DESCRIPTION OF THE INVENTION

The electrochemical treatment method of the present invention is applicable to a wide variety of metals, including metal alloys. Examples of metals which may benefit from treatment in accordance with the present invention include steels, stainless steels, and titanium and its alloys. The method is particularly beneficial for treatment of austenitic stainless steels. The method may be used to prevent mechanical degradation, or to improve surface properties following such degradation.

The electrolyte may be aqueous or non-aqueous in nature, although aqueous electrolytes are preferred for environmental reasons. Examples of suitable aqueous electrolytes include aqueous solutions of salts containing cation selected from the alkali metals, alkali earth metals, aluminium and ammonium, or other metal which, on electrolysis, does not deposit on to the surface of the metal substrate being treated, i.e. non-electroplatable metal ions. The method of the invention is, therefore, distinct from an electroplating technique as it does not result in deposition of any metallic element on to the surface of the metal being treated. Suitable counterions include hydroxide, carbonate, nitrite and nitrate. Preferred aqueous electrolytes are those of nitrogen-containing salts, such as nitrites, nitrates and ammonium salts, with sodium and potassium nitrites being particularly preferred, and sodium nitrite being the most preferred.

Suitable non-aqueous electrolytes include hydrocarbon solvents, such as alcohols, and nitrogen-containing solvents.

The concentration of the electrolyte will depend upon the effect desired of the treatment method, and, to an extent, the time available, as it is believed that more concentrated electrolytes may result in faster treatment times. Generally, however, the concentration of the electrolyte will be in the range of 1 molar to near saturated, preferably 5 to 15 molar.

The metal substrate to be treated may be immersed in a volume of the electrolyte, for instance in a treatment bath, or the electrolyte may be coated, sprayed or otherwise applied on to the surface of the metal substrate to be treated.

It is critical to the method of the present invention that electrolysis is conducted using alternating pulses of opposite polarity voltage and/or current, which may otherwise be referred to as alternating pulses of cathodic and anodic voltage and/or current Typically, the metal substrate will form one of two electrodes of an electrochemical cell, with the other electrode being formed from any conventional electrode material, such as graphite. The metal substrate is then subjected to anodic or cathodic electrolysis, depending on the voltage and/or current applied.

The frequency and amplitude of the alternating pulses, and the overall treatment time, are selected according to the effects desired of the method, and these effects are readily determinable by, for instance, X-ray diffraction (XRD). The frequency of the pulses and their amplitudes may vary throughout the treatment period, and for different polarities. For instance, it may be desirable to use a cathodic pulse which is longer and/or of higher amplitude than the subsequent anodic pulse.

Generally, however, the pulses will be less than half an hour in duration, and typically the pulses will be significantly shorter than this, for instance less than 10 minutes In duration. Typical voltages will lie in the range of plus or minus a few volts, or less, although higher voltages may be used, or may be needed when employing poorly conductive solutions. Overall treatment times can range from a matter of hours to days, with higher operating temperatures allowing for a reduction in treatment time.

A variety of different waveforms may be used for the alternating pulses. Examples include sinusoidal wavefroms, and indeed these are preferred as they are common in power supplies in industrial environments, square waveforms and triangular waveforms.

The method of the invention may be carried out at room temperature, e.g. about 20° C., up to the boiling point of the electrolyte. Temperatures in the range 50 to 120° C. tend to be preferred, with temperatures in the range 60 to 100° C., for example about 80° C., being most preferred.

After electrolysis, the treated metal may be subjected to heat treatment, at a temperature suitable to achieve further surface modification. Generally, a temperature of at least 300° C. will be required, and preferably at least 450° C., although this will depend upon the nature of the metal being treated, and the properties desired in the final metal. Generally, this heat treatment need only be carried out for a relatively short period of time, for instance 10 minutes to 2 hours, although longer heating times may be used if desired, according to the properties required in the final metal. It has been found that electrolysis followed by heat treatment results in a further reduction in the coefficient of friction, which coupled with an increase in hardness, results in enhanced resistance to galling.

While not wishing no be bound by theory, it is believed that the method of the invention may involve a phase transformation and/or a relaxation of stresses within the metal surface, rather than a coating or deposition of another species on to that surface. It could therefore, perhaps be considered a method of electrochemical annealing of the surface and near-surface material. Although the mechanisms of this electrochemical annealing are not yet clear, some aspects can be rationalised, at least in the aqueous system. In particular, during the cathodic phase of the treatment, water is reduced by electrolysis to hydrogen, which enters the metal surface causing microstructural changes as well phase transformations. Reduction of other components present in the electrolyte, for instance the nitrite ion to nitrogen, may result in deposition of other, reduced, species in the metal surface. Then, during the anodic phase of the treatment, any reduced hydrogen, and any other reduced species, generated in the prior cathodic phase of the treatment tends to be re-oxidised and dissolves in the electrolyte. The defects generated by ingress of hydrogen, and perhaps other species, leave vacancies after re-oxidation, and allow for surface relaxation of the metal atoms over very short range, giving the observed “rannealing” effect. The defects that remain are then available for penetration of further reduced atoms in the next cathodic phase of the treatment.

It has been reported that cathodic charging of austenitic stainless steels in some aqueous systems results in the formation of martensite, rendering the results of the present invention all the more surprising. Reference is made in this regard to A. P. Bentley et al, Met Trans. (1986) 17A:1593-1600 and H. Okada et al, Corrosion (1970)26:183-186.

The method of the present invention may be used in any application where surface hardness and resistance to wear and corrosion is required. Possible examples include the treatment of metals for use in cutting applications, such as knives, razor blades and saw blades; metals forming moving parts, or surfaces that are exposed to moving parts; metal or metal-coated containers subject to a wear phenomenon, for instance in the milk industry; in situ treatment of engineering structures and storage tanks; and treatment of metals in other environments subject to tribological activity.

### DETAILED DESCRIPTION OF THE DRAWINGS

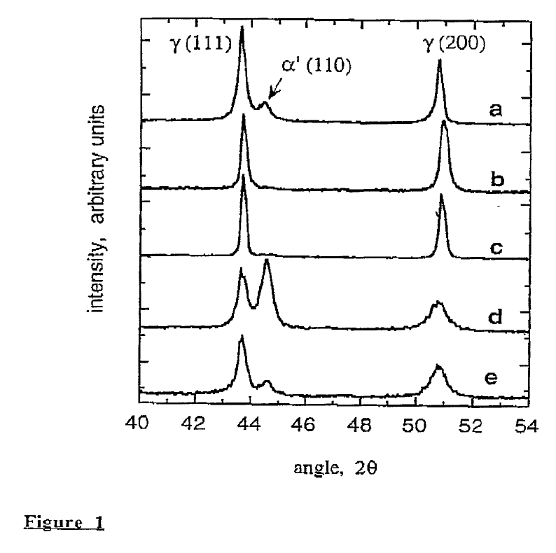

FIG. 1 is a series of X-ray diffraction patterns of 304 L stainless steel before and after treatment with the method of the present invention, and after conventional annealing.

The present invention is now further illustrated by way of the following examples.

Samples of an austenitic sheet stainless steel (1.2 mm thickness), containing 18% Cr, 8% Ni and 0.03% C (AISI type 3040L) were cut into 1 cm squares each carrying a thin shank from one corner to allow electrical contact, The surfaces of each were ground and polished to a 0.25 μm finish with successive grades of silicon carbide paper and diamond paste. X-ray diffraction of this surface showed the presence of the austenitic structure (Y) together with reflections from the martensitic structure (α′) as shown in FIG. 1(a). The martensitic structure, which is generated by the strain developed during mechanical surface preparation, has its most prominent reflection at 2θ=44.69°, representing the (110) reflection.

The surfaces of each specimen were then subjected to a series of anodic/cathodic electrochemical pulses in an aqueous solution of sodium nitrite of concentration SM at a temperature of 80° C. This was carried out using a two-electrode cell using high purity (99.997%) graphite cylinder as the counter electrode. Alternating voltage pulses of opposite polarity were applied using a bipolar high power supply (KEPCO, Model BOP 100-2 m), of −4.0 V for 277 seconds and +1.2 V for 56 seconds, the voltages being equivalent to applied electrode potential pulses between about −1.8 V (SCE) and about +0.28 V (SCE) (where SCE refers to the saturated calomel electrode scale). After 3 hours of electrochemical treatment (33 cycles) the specimen was withdrawn and washed thoroughly.

The resulting X-ray diffraction pattern showed that the reflections due to martensite had disappeared completely; see FIG. 1(b) The austenite peaks were substantially unchanged The same effect is achieved by conventional thermal annealing at 750° C. for 20 mins., in the absence of any electrochemical treatment, as shown by the X-ray diffraction pattern in FIG. 1(c), although temperatures in excess of 750° C. were required to achieve this effect in a reasonable time.

FIG. 1(d) shows the X-ray diffraction patter of the initial austentic steel after cold-rolling to achieve a 25% reduction in thickness. The pattern shows a large peak due to the (110) reflection from α′ martensite. This cold-rolled steel was then subjected to the same electrochemical treatment described above, but for 98 cycles. FIG. 1(e) shows the diffraction pattern for the resulting steel, with the peak due to martensite substantially reduced.

The method of the present invention gives rise to mechanical properties of the surfaces that are different from those achieved by thermal annealing. In the following, references to the hardness of the surfaces is hardness measured using a Vickers microhardness indenter (with a 50 g load). After grinding, the untreated stainless steel surface had an initial hardness of 205 Hv. Thermal annealing at 750° C. reduced the hardness to 196 Hv, consistent with the loss of strain-induced martensite. The annealed specimen regained its initial hardness on regrinding. In contrast, after the electrochemical treatment described above the hardness was increased to 235 Hv, despite the loss of the martensite. Moreover, when the surface had been electrochemically annealed and subsequently thermally annealed at the lower temperature of 550° C. for 20 mins. the hardness was significantly higher (252 Hv) than that achieved by thermal annealing alone.

It is concluded that the electrochemical treatment method, or annealing procedure, of the present invention induces relatively irreversible and stable changes into the stainless steel surfaces, involving both lose of the martensite phase and retention of surface hardening.

1. A method for treating a metal comprising subjecting the metal to electrolysis in the presence of an electrolyte using alternating pulses of voltage and/or current, said alternating pulses being of opposite polarity, wherein if the electrolyte is an aqueous electrolyte it is an aqueous solution of a salt selected from the group consisting of alkali metal salts, alkali earth metal salts, aluminium salts and ammonium salts.

2. A method according to claim 1, wherein the metal is austenitic stainless steel.

3. A method according to claim 1 or claim 2, wherein the electrolyte contains nitrogen4.

4. A method according to claim 3, wherein the electrolyte is an aqueous solution of a nitrogen-containing salt.

5. A method according to claim 4, wherein the electrolyte is an aqueous nitrite solution.

6. A method according to claim 5, wherein the electrolyte is aqueous sodium nitrite.

7. A method according to claim 1, wherein the alternating pulses have waveform selected from the group consisting of sinnusoial waveforms and square waveforms.

8. A method according to claim 1, which further comprises, after electrolysis, heat treatment of the metal.

9. A method according to claim 1, wherein the metal to be treated is in the form of a metal article or a part of a metal article for use in an environment in which it will be exposed to tribological activity.

10. A method according to claim 1, wherein the metal to be treated is for use as a moving part in an apparatus.

11. A method according to claim 1, which is carried out in situ on apparatus selected from the group consisting of engineering equipment and storage tanks.

12. A metal or metal article which has been subjected to a method as defined in claim 1.

13. Use of a method as defined in claim 1, to improve the resistance of austenitic stainless steel to mechanical degradation.

14. Use of a method as defined in claim 1, to remove or transform martensite from austenitic stainless steel.
